(19) United States
(12) Patent Application Publication
(10) Pub. No.: US 2009/0169857 A1
(43) Pub. Date: Jul. 2, 2009

(54) HIGHLY POROUS LAYERS MADE OF MOF MATERIALS AND METHOD FOR PRODUCING SUCH LAYERS

(75) Inventors: Richard Fischer, Bad Aibling (DE); Roland Fischer, Bochum (DE); Christof Woll, Bochum (DE); Felicitas Schroder, Bochum (DE); Stephan Hermes, Bochum (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: Sud-Chemie AG, Munchen (DE)

(21) Appl. No.: 11/995,241

(22) PCT Filed: Jul. 25, 2006
(86) PCT No.: PCT/EP06/07335

§ 371 Date: Jul. 22, 2008

(30) Foreign Application Priority Data
Jul. 29, 2005 (DE) 10 2005 035 762.8

(51) Int. Cl. B32B 3/26; B05D 5/00

(52) U.S. Cl. 428/304.4; 427/245

(57) ABSTRACT

The invention relates to a process for producing highly porous layers, which comprises
making available a substrate having a substrate surface;
modifying at least sections of the substrate surface so as to produce surface-modified sections in which anchor groups for metal ions are provided;
applying at least one MOF to the surface-modified sections of the substrate so as to produce a layer of the MOF.

The invention further relates to a composite comprising a substrate and a porous layer of an MOF located on the substrate.

The invention relates to a process for producing highly porous layers and also a composite comprising a substrate and a highly porous layer applied to at least sections of a substrate surface of the substrate.

Metal organic coordination polymeric compounds are of interest for many industrial applications. For example, these compounds can be used as catalysts or as support materials for heterogeneous catalysts, since owing to their high specific surface area and finely divided distribution of the catalyst, very high activities can be expected. A particularly interesting class of substances are the class of highly porous basic zinc carboxylates recently derived by Omar M. Yagi and coworkers (O. M. Yaghi, M. O'Keeffe, N. W. Ockwig, H. K. Chae, M. Eddaoudi, J. Kim, Nature 2003, 423, 705-714). Their prototype is MOF-5 in which Zn₄O units are linked via terephthalate bridges to form a zeolite-like three-dimensional cubic network. The compounds belonging to this class of substances are generally referred to as MOFs (MOF=metal organic framework). They are characterized in that metal atoms or metal ions are bound via at least bidentate ligands so that three-dimensional regular structures are obtained. The networks obtained have a crystal-like structure comprising regularly recurring structural elements. They comprise voids whose size is determined by the length of the bidentate ligands, which will hereinafter be referred to as “linker molecules”. In this structure, the metal atoms are located at the corners of a polygon, for example a cube, while the linker molecules are arranged between the metal atoms along the edges of the polygon or cube. MOFs have extremely high specific surface areas of up to 4500 m²/g and extremely high pore volumes of, for example, up to 0.69 cm³/cm³ in the case of MOF-177, which are surpassed by no other crystalline substance known hitherto. At the same time, these compounds have a comparatively high thermal stability and do not display any appreciable decomposition at temperatures of, for example, 350° C. These unique properties make the class of MOFs appear suitable for a whole series of applications. Thus, industrial applications as gas stores for, for example, hydrogen and methane, as gas sensors and as separation media have been proposed.

US 2004/0081611 A1 describes a process for preparing hydrogen peroxide, in which oxygen or an oxygen-supplying compound is reacted with hydrogen or a hydrogen-supplying compound in the presence of a catalyst. The catalyst used is a porous MOF which comprises at least one metal ion and at least one at least bidentate organic ligand which is coordinated to the metal ion.

U.S. Pat. No. 6,624,318 B1 describes a process for the epoxidation of organic compounds, in which an organic compound is reacted with at least one epoxidizing agent in the presence of a catalyst. The catalyst is formed by a porous MOF which comprises at least one metal ion and at least one at least bidentate ligand which is coordinated to the metal atom.

S. Hermes, M.-K. Schröter, L. Khodeir, M. Muhler, A. Tissler, R. W. Fischer and R. A. Fischer (accepted by Angew. Chem. Int. Ed. Engl., intended for publication) describe the loading of highly porous coordination polymeric host lattices by metal organic chemical vapor deposition. The MOF here serves as support into which a precursor compound of an active metal is initially introduced. After loading of the MOF with the precursor compound, the active metal can be set free, for example by irradiation of the precursor compound with light having a suitable wavelength, e.g. UV radiation.

WO 03/102000 A1 describes shaped bodies produced from MOFs. The MOFs are firstly made available in the form of a powder. The powder is then shaped by customary processes to give shaped bodies. Suitable processes are, for example, granulation or pelletization. For this purpose, a binder can, if appropriate, be added to the MOF. An alternative described is to apply the MOF to a porous substrate.

DE 103 55 087 A1 describes a process for the electrochemical preparation of a crystalline porous metal organic framework. The metal ion present in the MOF is introduced into the reaction system electrochemically by oxidation of the anode.

The MOFs described hitherto have been in the form of powders. However, for a series of applications it is desirable to provide the MOFs in the form of thin layers having a defined thickness. This applies particularly to applications in which MOFs are used as catalyst materials or as porous support materials for the immobilization of catalytically active components, e.g. molecularly defined catalysts or catalytically active metal, metal oxide and/or semiconductor nanoparticles.

It was therefore an object of the invention to provide a process which makes it possible to produce highly porous layers having a defined thickness.

This object is achieved by a process having the features of claim 1. Advantageous embodiments of the process are subject matter of the dependent claims.

The invention provides a process for producing highly porous layers, which comprises
making available a substrate having a substrate surface;
modifying at least sections of the substrate surface so as to produce surface-modified sections in which anchor groups for metal ions are provided;
applying at least one MOF to the surface-modified sections of the substrate so as to produce a layer of the MOF.

In the process of the invention, the substrate surface is firstly modified so that anchor groups for the metal ions are provided. For the purposes of the present invention, an anchor group is a group which, firstly, is fixed to the substrate surface and, secondly, has the ability to bind a metal ion. The anchor groups are preferably formed by molecules which firstly have a group which can form a bond to the substrate surface and secondly provide a group which is capable of binding a metal ion. These anchor groups form a monolayer on the substrate surface. Anchor groups used are generally groups which can form a generally coordinate bond to metal ions so that the metal ions are fixed to the substrate surface. As metal ions, it can be appropriate to choose the metal ions of the MOF which are to be fixed to the substrate surface. However, it is also possible firstly to coordinate metal ions which are different from the metal ions of the MOF to the anchor groups. The bond to the MOF is then established from these metal ions via appropriate polydentate, preferably bidentate, ligands.

If the MOF is brought into contact with the surface which has been prepared in this way, the anchor groups can effect nucleation or fixing of the MOF to the substrate surface. In this way, layers of the MOF can grow on the substrate surface in a very controlled way, with the layer thickness being able to be controlled very precisely by means of the deposition conditions, for example the deposition time, the saturation of the MOF solution or the temperature program employed for deposition of the MOF. The anchor groups fix the porous layer firmly to the substrate surface, so that the porous layer can be used as starting point for further modifications, for example by loading the porous layer with further compounds such as catalytically active compounds.

The substrate surface can be modified so that only sections of the substrate surface are provided with the anchor groups or with the layer of the MOF. It is possible to use customary measures for this purpose, by, for example, providing sections of the substrate layer with a surface coating on which no anchor groups are provided. However, it is also possible for the substrate surface to be selectively modified in only particular sections by, for example, selectively oxidizing these or providing them with a layer of a metal, for example a thin gold layer, so that the anchor groups are provided only in the pretreated regions of the substrate surface. However, it is also possible for, for example, regions on the substrate surface in which anchor groups are provided to be defined by printing, while groups which cannot by bind metal ions, for example alkyl groups, are provided in other regions. If the MOF is then applied, nucleation or fixing of the MOF occurs only in the regions in which anchor groups are provided.

For the production of the highly porous layer, anchor groups for the fixing of metal ions to the substrate surface are firstly provided. This is preferably effected by producing the surface-modified sections by applying a spacer molecule which has at least one anchor group for metal ions and at least one head group which can bond to the substrate surface to at least sections of the substrate surface. For the purposes of the invention, spacer molecules are molecules which are at least bifunctional and have a connecting group between anchor group and head group, so that the anchor group can be provided at a distance from the substrate surface. The connecting group is appropriately selected so that a certain mobility of the anchor group relative to the position of the head group is made possible, so that the anchor group can match its position to the dimensions of the MOF. The spacer molecule preferably has a linear, i.e. stretched, structure which is preferably unbranched. The head group effects fixing of the spacer molecule to the substrate surface. The head group can be connected to the substrate surface via a coordinate bond or via a covalent bond. The bonding of the head group to the substrate surface results in formation of a monomolecular layer of the spacer molecule which is fixed to the substrate surface. At the same time, a layer of anchor groups which are available for fixing of metal ions is produced.

The fixing of such monolayers (SAMs) is effected by processes known per se. Reference may be made by way of example to processes as have been described by Q. Liu, J. Ding, F. K. Mante, S. L. Wunder, G. R. Baran, Biomaterials 23 (2002) 3103-3111, and by J. P. Folkers, C. B. Gorman, P. E. Laibinis, S. Buchholz, G. M. Whitesides, R. G. Nuzzo, Langmuir 1995, 11, 813-824.

The spacer molecules provide a connection between the substrate surface and the porous layer of the MOF. The spacer molecules are preferably selected so that they can adapt to the structure of the MOF. In a preferred embodiment, the spacer molecule has the formula A-R¹—K, where:
A: an anchor group selected from among —OH, —COOH, pyridyl, —NR²₂, —SR⁴, where R², R⁴ are each hydrogen or an alkyl radical having from 1 to 6 carbon atoms and R⁴ may also be —SR²;
Z: a head group selected from among —SR⁴, —SiX₃, —COOH, —C(O)NHOH, where X is halogen or an alkoxy group having from 1 to 6 carbon atoms and R⁴ is hydrogen, an alkyl radical having from 1 to 6 carbon atoms or SR², where R² is as defined above;
R¹: an alkylene radical having from 1 to 20 carbon atoms, an arylene radical having from 6 to 18 carbon atoms or an aralkylene radical having from 7 to 30 carbon atoms, where the radicals may also be perfluorinated or partially fluorinated.

The head group is selected according to the structure of the substrate surface. If hydroxy groups are available on the surface, for example due to a layer of silicon dioxide, aluminum oxide or another metal oxide which still has hydroxy groups, the head group used can be, for example, an Si(OCH₃)₃ group which can react with the hydroxy group to form an Si—O—Si bond so that the spacer molecule is fixed to the substrate surface via a covalent bond. If the substrate surface is formed by a thin gold layer or a similar material, the head group can be, for example, a thiol group or a disulfide which can form a covalent or coordinate bond to the substrate surface.

As anchor group, a group which can form a preferably coordinate bond to the metal ion of the MOF is selected. If a pyridyl radical C₅H₃R³N is selected as anchor group, the pyridyl group can be unsubstituted or be substituted by further groups, preferably electron-donating groups. R³ can be hydrogen or, for example, an alkyl group having from 1 to 6 carbon atoms, in particular a methyl group, an amino group or an alkylenamino group. If the substituent itself is capable of coordination to the metal atom, it can support the coordination of the metal atom and thus improve the bonding of the MOF to the substrate. The substituents are preferably arranged in the trans position relative to the ring nitrogen. A carboxyl group is particularly preferably selected as anchor group, since in the previously known MOFs, preference is given to using linker molecules which likewise have carboxyl groups and the anchor group of the spacer molecule is therefore readily inserted into the MOF structure.

A connecting radical R¹, usually a hydrocarbon radical, is provided between head group and anchor group. This radical is if possible made sufficiently flexible for very good matching of the anchor groups to the structure of the MOF to be able to be achieved. The radical R¹ is preferably unbranched. Preference is given to using linear alkylene chains which have from 1 to 20 carbon atoms, preferably from 10 to 20 carbon atoms. The alkylene chains can also be partially fluorinated or perfluorinated. Furthermore, for example, biphenyls or oligophenyls which are linked in the 1,4 positions can also be used as connecting radicals R¹.

In principle, MOF layers can be produced on all customary surfaces. However, the substrate surface may be surface-treated at least in the sections in which bonding of the spacer molecules is to occur, so that groups for the bonding of the head groups are provided in a sufficient density. Such a surface treatment can, for example, be an oxidation by means of which hydroxy groups are made available on the substrate surface. For example, anodic oxidation of aluminum or silicon makes it possible to produce a thin layer of aluminum oxide or silicon oxide which still has hydroxy groups for bonding of the head groups. Likewise, a glass surface can be lightly etched so that hydroxy groups are likewise produced. In the case of surfaces formed by organic polymers, for example plastic films, irradiation with high-energy radiation, corona treatment or oxidation makes it possible to produce groups which can then be utilized for bonding of the head groups of the spacer molecule. The production of such layers of spacer molecules on substrate surfaces is known per se, so that a person skilled in the art can make recourse to known processes here.

To apply the MOF layer to the modified substrate surface, preference is given to providing a solution of at least one metal ion and at least one at least bidentate linker molecule and bringing the solution into contact with at least the sections of the substrate surface on which a layer of the MOF is to be produced.

To provide the solution, the metal ion and the linker molecule are dissolved in a suitable solvent. It is possible in principle to work in the same way as in the previously known preparation of MOFs. Since the deposition of the MOF on the substrate surface competes with the crystallization of the MOF from the solution, the conditions such as concentration of the solution or its temperature or the cooling rate of the saturated solution are preferably selected so that deposition on the substrate surface occurs preferentially. Here, the metal ions are presumably firstly bound by the anchor groups provided on the substrate surface. Further linker molecules can then bond to the metal ions, so that the formation of the MOF is initiated. The MOFs can in principle also be present in nanodisperse form so that the structure of the MOF has already been partially preformed. These nanoparticles can then be bound by the anchor groups provided on the substrate surface and then act as nucleus for further growth of the layer. The linker molecules and the spacer molecule preferably have a different structure.

The preferred procedure is to prepare the solution by dissolving the at least one metal ion and the at least one at least bidentate linker molecule in a concentration close to the saturation limit of the MOF at a first, relatively high temperature, bringing at least the modified sections of the substrate surface on which the MOF is to be deposited into contact with the solution and cooling the solution to a second, lower temperature at which the MOF grows on at least the sections of the substrate surface.

In this embodiment of the process of the invention, the procedure is thus to prepare a solution of the constituents of the MOF, i.e. metal ions and linker molecules, in a suitable solvent, with the concentration of the components at the given temperature being chosen so that no MOF yet precipitates. The solution can then, if appropriate, be preincubated for a relatively long period of time, for example from 30 minutes to a number of hours, for example up to 72 hours, so that fragments of the MOF can form in the solution. The solution can then be filtered to remove relatively large particles of the MOF which have formed during the incubation. The appropriately pretreated substrate is then brought into contact with the cooled solution so that the MOF deposits on the substrate surface in a controlled fashion. Cooling rate, crystallization temperature and treatment time are selected so that a layer of the MOF having the desired thickness is obtained.

Preference is given to firstly pretreating (incubating) the MOF reaction solution at 60-90° C., then initiating crystallite growth at 100-120° C. and then introducing the surface-modified substrate into the MOF reaction solution at a reduced temperature in the range 0-80° C., particularly advantageously at 25° C. The parameters for the growth of the MOF layer can be determined by means of appropriate trials. The coating time, i.e. the time for which the substrate remains in the MOF reaction solution, is preferably in the range from 1 to 12 hours, depending on the desired layer thickness.

The substrate can be brought into contact with the finished solution of the constituents of the MOF. However, it is also possible to prepare the solution of the constituents of the MOF in the presence of the substrate and incubate the entire system jointly from the beginning.

These processes make it possible to produce layer thicknesses ranging from about 10 nm up to a number of μm.

It is also possible in principle to build up the MOF directly on the substrate surface, with the layer of the MOF being produced stepwise by treating at least the modified sections of the substrate surface which are to be coated with the MOF layer sequentially at least with a solution of the at least one metal ion and with a solution of the at least one at least bidentate linker molecule. Here, the substrate provided with anchor groups can firstly be dipped in a solution of the metal ion. The metal ions are then bound to the anchor groups. The substrate is taken from the solution of the metal ion and, if appropriate after a rinsing step, dipped into a solution of the at least bidentate linker molecule so that the linker molecules can then attach themselves to the metal atoms which have previously been fixed to the anchor groups. The substrate is once again taken from the solution of the linker molecule and, if appropriate after another rinsing step, dipped into the solution of the metal ion again. Repetition of those steps enables layers having a particular thickness to be built up precisely.

As metal ion for the formation of the MOF, it is possible in principle to choose any metal ion which is capable of bonding the linker molecule. Examples of such metal ions are Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, Bi⁺. The metal ion is particularly preferably selected from the group consisting of the ions of Zn, Sn, In, Ti, Cu, Fe. The metal ion is very particularly preferably Zn²⁺.

The metal ions are dissolved in the form of suitable salts in a suitable solvent. Suitable salts are, for example, the salts of organic acids such as acetates or formates, and also inorganic acids such as the hydrohalic acids, sulfuric acid or nitric acid. The salts should be soluble in the solvent selected.

The at least bidentate linker molecule has at least two functional groups which can form a coordinate bond to the metal ions of the MOF. Suitable functional groups are, for example: —COOH, —CS₂H, —NO₂, —B(OH)₂, —SO₃H, —Si(OH)₃, —Ge(OH)₃, —Sn(OH)₃, —Si(SH)₃, —Ge(SH)₃, —Sn (SH)₃, —PO₃H, —AsO₃H, —AsO₄H, —P(SH)₃, —As(SH)₃, —CH(RSH)₂, —C(RSH)₃, —CH(RNH₂)₂, —C(RNH₂)₃, —CH(ROH)₂, —C(ROH)₃, —CH(RCN)₂, —C(RCN)₃, where R can be an alkylene group having from 1 to 5 carbon atoms. The at least two functional groups can in principle be connected by any organic group as long as this organic group does not hinder the formation of the coordinate bond to the metal ion. Suitable organic groups which connect the at least two organic groups are preferably saturated or unsaturated aliphatic groups having preferably from 1 to 20, particularly preferably from 2 to 10, carbon atoms, aromatic groups having from 5 to 30, in particular from 6 to 20, carbon atoms and also mixed aliphatic-aromatic groups having from 6 to 30 carbon atoms. The aliphatic groups can be linear, branched or cyclic. The aromatic groups can have one or more benzene rings, preferably from 1 to 5 benzene rings, with these also being able to be present in fused form. The aliphatic or aromatic groups can also have one or more heteroatoms such as N, O, S, B, P, Si or Al.

The solvents for the preparation of the MOF should be inert toward the reaction of the metal ion and the linker molecule and also be sufficiently polar to be able to dissolve the components of the MOF. Suitable solvents are, for example, dimethylformamide, diethylformamide, N-methylpyrrolidone, dimethyl sulfoxide, chlorobenzene, fluorobenzene, water, alcohols such as ethanol or propanol and mixtures of these solvents.

The at least bidentate linker molecule used for preparing the MOF is preferably selected from among compounds of the formula Z-R⁵-Z, where:
Z: a carboxyl group, a carbamide group, a hydroxy group, a thiol group, an amino group or a pyridyl group;
R⁵: an at least divalent hydrocarbon radical selected from the group consisting of

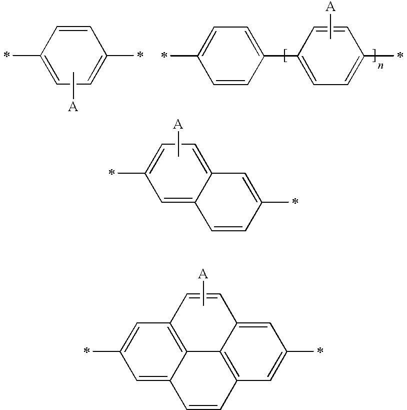

where n is an integer from 1 to 5 and A represents hydrogen, alkyl groups having 1-6 carbon atoms, alkenyl groups having 2-6 carbon atoms, alkoxy groups having 1-6 carbon atoms and from 1 to 3 oxygen atoms, halogen atoms or amino groups, with A being able to be identical or different on each occurrence.

Particular preference is given to A being hydrogen and Z being a carboxyl group. If Z is a pyridyl group, R⁵ can also be a single bond so that the linker molecule is formed, for example, by 4,4′-bipyridyl. Particular preference is given to R⁵ being a phenylene radical. From these constituents, it is possible to prepare, for example, MOF-5.

Particularly preferred linker molecules are terephthalic acid, 2,5-dihydroxyterephthalic acid, 1,2,3-benzenetricarboxylic acid, 1,3,5-benzenetricarboxylic acid, 2,6-naphthalenedicarboxylic acid and 2,2′-bipyridine-5,5′-dicarboxylic acid.

The MOF layers can in principle be applied to any desired substrate which can, if appropriate, also be appropriately pretreated in order to improve adhesion. The substrate can be, for example, a glass plate or a thin metal film composed of gold, silver or a similar metal which can, for example, also serve as electrode if the MOF layer is to perform, for example, the function of a sensor. A preferred substrate is a silicon wafer. This can be processed by known methods so that the MOF layer according to the invention can form, for example, part of an electronic circuit.

The MOF layer can be further modified, for example by being given catalytic properties. For this purpose, it is possible, for example, to introduce an active metal into the voids of the MOF. For the purposes of the present invention, an active metal is a metal which catalyzes a particular reaction, for example palladium which can act as hydrogenation catalyst.

Introduction of the active metal is effected via suitable precursors, known as active metal precursors.

An active metal precursor is generally understood to be a compound from which the active metal can be liberated. In the process of the invention, compounds which contain at least one atom of the active metal and at least one group which is bound via a carbon skeleton to the active metal atom are used as active metal precursors. The ligator atom is selected from among oxygen, sulfur, nitrogen, phosphorus and carbon. The active metal preferably bears organic groups, i.e. groups which comprise at least one carbon atom in addition to the ligator atoms O, S, N and P. These organic groups preferably have from 1 to 24 carbon atoms, in particular from 1 to 6 carbon atoms.

Apart from the ligator atom, further heteroatoms or heteroatomic groups which coordinate as Lewis bases to the active metal and can thereby stabilize the active metal precursor may be bound to the carbon skeleton. Suitable organic groups are, for example, alkoxides or amino-functionalized alkoxides. The active metal precursors are selected so that they can penetrate into the pores of the MOF. The diameter of the active metal precursor in at least two dimensions is preferably not more than 90% of the pore diameter of the MOF, particularly preferably not more than 80% and very particularly preferably not more than 50% of the pore diameter. Very particular preference is given to the diameter of the active metal precursor in all three spatial dimensions being not more than 90%, in particular not more than 80%, preferably not more than 50%, of the pore diameter of the MOF.

The active metal precursors are preferably introduced via the gas phase, since very high loading densities can be achieved in this way. On application, the active metal precursor generally does not yet react with the MOF of the porous layer but is adsorbed on the surface or in the pores of the porous layer by comparatively weak interactions. The MOF and the active metal precursor thus form an adduct from which the active metal precursor can largely diffuse off again, for example as a result of heating. The bonding of the active metal precursor to the MOF can occur, for example, via polar groups which are available in the MOF. If there are no groups available for a coordinate or ionic interaction, adduct formation can occur on the basis of van der Waals interactions.

After introduction of the active metal precursor into the MOF, the active metal can be liberated. This can be effected, for example, by reduction with hydrogen gas or by illumination with high-energy radiation, with the groups on the active metal being split off and the active metal being deposited in the voids of the MOF.

In a further embodiment of the process of the invention, a promoter metal is introduced into the voids of the MOF in addition to the active metal.

In this embodiment of the process of the invention, at least one promoter metal is thus present in addition to the active metal precursor in the adduct of MOF and active metal precursor. For the purposes of the present invention, a promoter metal is a metal which forms the promoter in the finished catalyst. The promoter is generally present in the form of an oxide in the catalyst. In the case of a catalyst for the synthesis of methanol, zinc and, if appropriate, aluminum can form the promoter metals and copper can form the active metal. Further suitable promoter metals are, for example, tin, indium and titanium.

In the adduct, the promoter metal is preferably not present in the form of the metal but in oxidized form, for example as oxide or metal complex. However, these promoters can also be present in the form of metals in the finished catalyst. Such promoter metals make it possible, for example, to poison noble metal particles, i.e. the active metals, deliberately by alloy formation so as, for example, to increase the selectivity of the catalyzed reaction. The promoter metal can be present in the MOF or can also be introduced as independent compound into the adduct. The promoter metal or a suitable compound of the promoter metal can be introduced into the adduct, i.e. be applied to the porous layer of the MOF, before liberation of the active metal. However, it is also possible firstly to apply the active metal precursor to the layer of the MOF and liberate the active metal and then apply the promoter metal, generally in the form of a suitable precursor, to the porous layer. In one embodiment of the process of the invention, the promoter metal is likewise applied in the form of a precursor, preferably in the form of a metal organic compound, to the porous layer and the promoter metal or a suitable compound of the promoter metal, e.g. an oxide, is liberated from the precursor. Liberation can, for example, be effected by illumination with activating radiation as in the case of the active metal precursor. The promoter metal or the promoter metal compound is preferably deposited like the active metal in nanodisperse form on the porous support.

The precursor of the promoter metal therefore preferably comprises at least one promoter metal and at least one group which is bound via a ligator atom to the promoter metal. Bonding can occur either via a σ bond or via a π bond. The ligator atom can, as in the case of active metal precursor, be selected from among oxygen, sulfur, nitrogen, phosphorus and carbon. The promoter metal preferably bears organic groups, i.e. groups which have at least one carbon atom in addition to the ligator atoms O, S, N and P. These organic groups preferably have from 1 to 24 carbon atoms, in particular from 1 to 6 carbon atoms. The promoter metal particularly preferably bears small ligands such as trialkylphosphines in which the alkyl groups preferably each have from 1 to 6 carbon atoms, and also isonitriles, nitrites, cyclopentadienyl groups, alkenyl groups or alkyl groups, preferably methyl groups.

The groups bound to the promoter metal preferably have from 1 to 24, particularly preferably from 1 to 6, carbon atoms and may, if appropriate, also contain groups which are bound via a heteroatom and can act as Lewis bases to stabilize the precursor of the promoter metal. The groups in the precursor of the promoter metal are preferably selected from among alkyl groups, alkenyl groups, aryl groups, a cyclopentadienyl radical and its derivatives and also a hydride group.

In the process of the invention, particular metal organic compounds are thus advantageous as active metal precursors or as precursor for the at least one promoter metal.

For the present purposes, metal organic compounds are:

1. metal complexes in which there are direct metal-carbon bonds;

2. metal complexes in which there is no metal-carbon bond but (coordinated) ligands which are organic in nature, i.e. belong to the family of hydrocarbon compounds or derivatives thereof, are present.

“Metal organic” thus distinguishes from purely inorganic metal complexes which contain neither metal-carbon bonds nor organic ligands.

The order in which the at least one active metal precursor and, if appropriate, the precursor of the at least one promoter metal are applied to the porous layer is not subject to any restrictions. The porous layer of the MOF can firstly be laden with the active metal precursor and the precursor of the promoter metal can then be applied before the active metal and, if appropriate, the promoter metal are fixed in the porous layer by illumination with the activating radiation. However, it is also possible firstly to introduce the precursor of the promoter metal into the porous layer and subsequently the active metal precursor and then fix these in the porous layer of the MOF by illumination with the activating radiation. It is also possible firstly to introduce the active metal precursor into the layer of the MOF and fix the active metal by irradiation with the activating radiation. Furthermore, the promoter metal precursor can be applied to the MOF which has already been laden with the active metal and be fixed there. The fixing of the promoter metal or the promoter metal compound, e.g. an oxide of the promoter metal, can be effected by illumination with the activating radiation or else by other methods, e.g. by oxidation or reduction with a suitable gaseous oxidizing or reducing agent. It is also possible to apply the active metal precursor and the precursor of the promoter metal alternately a number of times to the porous layer. The active metal precursor or the precursor of the promoter metal is firstly physisorbed or chemisorbed by the MOF, in particular on the surfaces of the voids of the MOF. The active metal is then liberated from the active metal precursor and deposited or the promoter metal or a suitable compound of the promoter metal is liberated from the promoter metal precursor and deposited by illumination with the activating radiation.

The active metal and the promoter metal can also be introduced into the porous layer of the MOF in such a way that active metal precursor and promoter metal precursor form a redox pair, so that active metal and promoter are deposited in finely divided form as an intimate mixture in the voids of the MOF by reaction of the precursors.

In this embodiment, at least one active metal precursor which comprises at least one active metal in a reducible form and at least one group which is bound via a ligator atom selected from among oxygen, sulfur, nitrogen, phosphorus and carbon to the active metal atom is introduced into the porous layer of the MOF. The active metal precursor is reduced by means of a reductor which comprises at least one promoter metal and at least one hydride group and/or an organic group which is bound via a carbon atom to the promoter atom. The reductor or the promoter metal present in this is subsequently converted into the promoter. The promoter is usually formed by an oxide of the promoter metal.

In this embodiment, the active metal precursor preferably has at least two groups which are bound via a ligator atom to the active metal atom, with the ligator atom being selected from among oxygen, sulfur, nitrogen, phosphorus and carbon.

The promoter metal precursor acting as reductor in this embodiment comprises at least one promoter metal and at least one hydride group and/or an organic radical which is bound via a carbon atom to the promoter metal. Bonding can be effected via a σ bond or via a π bond. If the groups on the active metal and on the promoter metal are bound via a carbon atom to the metal atom, the molecular weight of the groups of the promoter metal precursor is preferably lower than the molecular weight of the groups of the active metal precursor. The groups bound in the promoter metal precursor preferably have from 1 to 24, particularly preferably from 1 to 6, carbon atoms and may, if appropriate, also contain groups bound via a heteroatom which can act as Lewis bases to stabilize the promoter metal precursor. The groups in the promoter metal precursor are preferably selected from among alkyl groups, alkenyl groups, aryl groups, a cyclopentadienyl radical and derivatives thereof and also a hydride group. For the purposes of the present invention, a promoter metal is the metal which forms the promoter in the finished catalyst. The promoter is generally present as oxide. In the case of a catalyst for the synthesis of methanol, zinc and if appropriate aluminum form the promoter metals.

The promoter metal precursor acting as reductor preferably has at least two hydride groups and/or organic groups which are bound via a carbon atom to the promoter atom. This group is preferably selected from the group consisting of alkyl groups, alkenyl groups, aryl groups, a cyclopentadienyl radical and derivatives thereof.

The order in which the at least one active metal precursor and the at least one promoter metal precursor are introduced into the porous layer of the MOF is in principle not subject to any restrictions. As in the case of the above-described embodiment of the process of the invention in which the active metal is liberated from the active metal precursor by means of high-energy radiation or a suitable gaseous reducing agent, the layer of the MOF can firstly be impregnated with the active metal precursor and the promoter metal precursor can then be applied to fix the active metal in the voids of the MOF. However, it is also possible firstly to introduce the promoter metal precursor into the voids of the MOF and subsequently introduce the active metal precursor. It is also possible to introduce the active metal precursor and the promoter metal precursor alternately a number of times into the porous layer of the MOF.

As indicated above in the case of the process, a coating of the MOF which makes many applications possible is obtained. The invention therefore further provides a composite of a substrate and a highly porous layer applied to at least sections of a substrate surface of the substrate, with the layer being made up of an MOF. The layer of the MOF is fixed to the substrate surface via a layer formed by anchor groups.

The porous layer can take up further compounds in the voids of the MOF, as a result of which the properties of the porous layer, for example its electrical conductivity or its electric capacity, are altered. The porous layer of the MOF can therefore act as element of a sensor. However, it is also possible to incorporate metals in nanodisperse form into the voids of the MOF so that the porous layer acquires catalytic properties.

The MOF is preferably made up of at least one metal ion and at least one at least bidentate linker molecule. The class of MOFs is known per se. The composite of the invention is accordingly obtained by these MOFs being bound in the form of a thin layer to the substrate. Suitable metal ions and linker molecules have been mentioned above for the process. The metal ion is particularly preferably selected from among Zn, Sn, In, Ti, Cu, Fe.

The thickness of the MOF layer is selected as a function of the intended application. If the MOF layer acts as part of a sensor element, a very small layer thickness is preferably selected in order to make rapid response of the sensor or rapid return to the rest state possible. In an application as catalyst, greater layer thicknesses are also used in order to ensure a high conversion in the catalyzed reaction. The thickness of the highly porous layer is preferably less than 100 μm. In a use as catalyst, the layer thickness is preferably in the range from 10 nm to 100 μm, particularly preferably in the range from 10 to 90 μm. In a use as sensor, preference is given to layer thicknesses in the range from 5 nm to 2 μm, particularly preferably from 10 nm to 100 nm.

The layer of the MOF is to act as catalyst, an active metal is incorporated into the highly porous layer in a preferred embodiment. Suitable active metals have been discussed above. In addition to the active metal, a promoter metal or a promoter metal compound can also be incorporated into the MOF.

The invention is illustrated below with the aid of examples and with reference to the accompanying figures. In the figures:

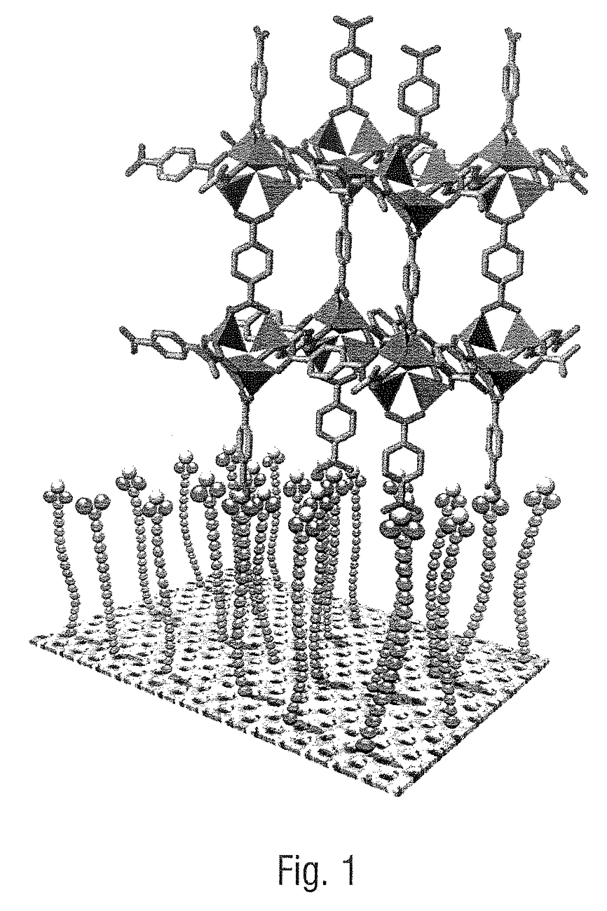

FIG. 1: a model depiction of the bonding of MOF-5 to COOH-terminated spacer molecules on Au(111);

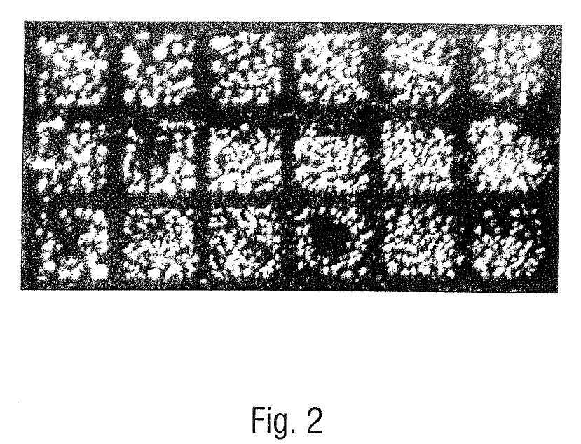

FIG. 2: a thin structured MOF-5 layer grown on a mixture-terminated COOH/CF₃—SAM on Au(111) model substrate as per Example 1;

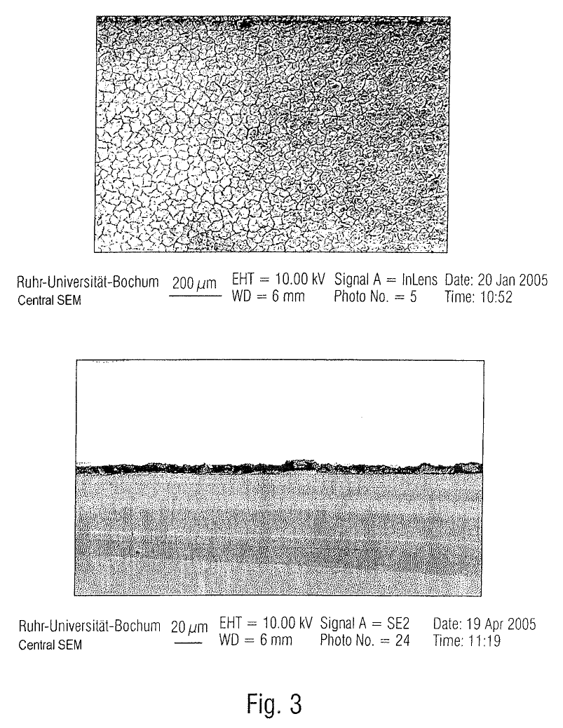

FIG. 3: a dense IR-MOF-8 layer (10 μm) grown on a COOH-SAM on a SiO₂/Si model substrate as per Example 2 (plan view at top, cross section at bottom).

In FIG. 1, the bonding of the MOF to the substrate surface is depicted in the form of a model. Spacer molecules are located on the substrate surface and bear an anchor group at their end most distant from the substrate surface. Metal atoms, for example Zn²⁺ ions, are coordinated to these anchor groups. Carboxyl groups of terephthalic acid are in turn coordinated to these metal ions and form the linker molecules of the MOF. These linker molecules then lead to the zinc atoms present in the MOF structure so that a three-dimensional network in the form of adjoining cubes is formed.

The process of surface-controlled growth of MOF crystallites or a nanocrystalline to microcrystalline MOF layer proceeds, according to present-day conceptions, as roughly outlined below. Pretreatment of the MOF reaction solution composed as in the prior art for the synthesis of macrocrystalline MOF powder materials at elevated temperature for a precisely determined incubation time results in supersaturation of the solution with MOF nuclei below the visibility limit (turbidity) in the colloidal or nanosize range due to the self-aggregation of SBUs (secondary building units) and the organic linker molecules. A critical factor for the surface-controlled (and possibly also laterally selective) growth of the layer is then prevention of rapid, homogeneous crystallite growth after initiation of growth by cooling of the MOF reaction solution with simultaneous introduction of the surface-modified substrate into the MOF reaction solution. The nucleation and growth of the MOF crystallites on the substrate surface provided with anchor groups is kinetically favored over the homogeneous phase (lower activation energy or entropy). Preferential crystallite growth on the surface of the substrate therefore takes place. Chemical bonds are formed between the MOF crystallites and the surface modified with anchor groups.

### EXAMPLES

General method: to produce an MOF layer, the substrate or support material is firstly functionalized with an organic monolayer (SAM) capable of binding an MOF. The MOF reaction solution is made up and incubated at elevated temperature for a number of hours. After a brief increase in temperature to the commencement of crystallization, the solution is filtered and the substrate is brought into contact with the supersaturated MOF reaction solution at low temperature. The MOF layer thickness is set by means of the crystallization time.

### Example 1

### MOF-5@μCpSAM/Au

A micropressure (μCP)-structured monolayer (SAM) of the spacer molecules 16-mercaptohexadecanoic acid and 1H,1H,2H,2H-perfluorododecanethiol on Au(111) on TiO₂@Si is introduced into a supersaturated MOF-5 reaction solution. This is produced from Zn(NO₃)₂x.6H₂O (3.57 g) and terephthalic acid (0.67 g) in 100 ml of diethylformamide which has been incubated at 80° C. for 72 hours and then slowly heated to 105° C. until crystallization commences. After filtration and cooling to 25° C., the substrate with the SAM (above) is introduced into the reaction solution. After 5 hours at 25° C., a structured MOF-5 layer has grown on the substrate. Shorter or longer crystallization times lead to correspondingly different layer thicknesses. Very thin MOF-5 layers of about 10-20 nm are obtained after only 1 hour, while comparatively thick layers up to about 10 μm are formed after 6-12 hours. The MOF film adheres to the substrate and cannot be removed by, for example, repeated washing cycles with ethanol. Scanning electron microscopy (SEM) and element-dispersive X-ray fluorescence analysis (EDX) and also photoelectron spectroscopy (XPS) show the expected elemental composition of the MOF layer of Zn and O and also C. The crystalline structure of the film is confirmed by X-ray diffraction (PXRD) in agreement with an authentic microcrystalline MOF-5 powder sample.

FIG. 2 shows an optical micrograph of the substrate surface. The regions coated with MOF crystallites can be recognized in the form of circular light-colored regions while the dark regions correspond to sections in which no MOF crystallites have grown or adhere.

### Example 2

### IR-MOF-8@COOH-SAM/SiO2

A COOH-terminated SAM of 7-oct-1-enyltrichlorosilane (OETS) was produced on an Si(111) wafer having a natural SiO₂/OH layer (100 nm) by standard methods (silanization) and the terminal COOH function was introduced according to the literature method by functionalization of the terminal double bond. [Q. Liu, J. Ding, F. K. Mante, S. L. Wunder, G. R. Baran, Biomaterials 2002, 23, 3103-3111]. A reaction solution for the synthesis of IR-MOF-8 comprising Zn(NO₃)₂×6H₂O (0.55 g) and 2,6-naphthalenedicarboxylic acid (0.06 g) in 100 ml of diethylformamide was then made up, incubated at 90° C. for 96 hours, slowly heated to 110° C. until the commencement of crystallization, filtered and cooled to 40° C. The COOH-SAM-functionalized substrate prepared above (wafer about 10×25 mm) was introduced into this solution and taken out after 12 hours. Characterization was carried out as in Example 1 by SEM-EDX, XPS and PXRD.

FIG. 3 shows a scanning electron micrograph of the 10 μm thick IR-MOF-8 layer obtained. The MOF layers comprise closely packed or fused MOF crystallites having typical crystallite dimensions in the range from 10 nm to 10 μm, depending on the conditions. These primary crystallites and thus the MOF coating obtained still contain solvent, e.g. diethylformamide molecules from the MOF reaction solution which are present in the pores or voids of the MOF lattice. This solvent can be removed by diffusive exchange with chloroform or other volatile solvents. Gentle drying under reduced pressure of the MOF layer which has, for example, been washed with chloroform leads to MOF layers having empty pores as a result of the volatile exchange solvent, e.g. chloroform, being quantitatively desorbed.

### Example 3

### {Pd@MOF-5}@COOH-SAM/Au

Using a method analogous to Example 1, a layer of MOF-5@COOH-SAM/Au is produced by preparing an SAM of 16-mercaptohexadecanoic acid on Au(111) by standard methods and then coating it with MOF-5. The MOF-5 layer obtained is freed of adsorbed diethylformamide solvent in a manner analogous to Example 2 by immersing and washing the coated substrate in chloroform three times (6 hours in each case) and drying it gently under reduced pressure (1 Pa dynamic vacuum, 25° C.) over a period of 2 hours. The resulting MOF-5 layer which has been freed of solvent is then exposed to the vapor of (η⁵—C₅H₅)Pd(η³—C₃H₅) (1), η³-allyl-η⁵-cyclopentadienyl-palladium(II) (1 Pa, static vacuum, 50° C.) by placing a sample of the red palladium compound (100 mg) in a glass boat next to the dried layer of MOF-5@COOH-SAM/Au in an evacuated and sealed reaction tube. After a few minutes, the MOF-5-coated substrate becomes red, while comparative substrates which have not been coated with MOF-5, namely Au(111) and COOH-SAM/Au, remain unchanged. In a subsequent step, the MOF-5 layer which has been laden with the palladium compound 1 is exposed to a hydrogen/nitrogen gas atmosphere (5% of H₂, 95% of N₂) at 25° C. and atmospheric pressure, resulting in the coating becoming black in an instant. All volatile components are subsequently removed in a dynamic vacuum (1 Pa, 25° C.) (10 min). The material obtained {Pd@MOF-5}@COOH-SAM/Au is characterized by SEM-EDX, XPS, PXRD as in Examples 1 and 2. The presence of the unchanged crystalline MOF-5 structure is revealed by comparison with a microcrystalline MOF-5 sample by means of the characteristic reflections of the X-ray diffraction pattern. The presence of Pd nanoparticles is indicated by a broad reflection structure at about 40° (2 theta). Analysis by means of EDX and XPS confirms the expected elemental composition of the coating comprising Zn, O, C and Pd and demonstrates the additional presence of the palladium component as elemental Pd(0) in contrast to cationic Zn(II) from the MOF-5.

1. A process for producing highly porous layers, which comprises
making available a substrate having a substrate surface;
modifying at least sections of the substrate surface so as to produce surface-modified sections in which anchor groups for metal ions are provided, wherein the surface-modified sections are produced by applying a spacer molecule which has at least one anchor group for metal ions and at least one head group which can bond to the substrate surface to at least sections of the substrate surface, and;
applying at least one MOF to the surface-modified sections of the substrate so as to produce a layer of the MOF.

2. (canceled)

3. The process as claimed in claim 1, wherein the spacer molecule has the formula A-R¹—K, where:
A: an anchor group selected from the group consisting of —OH, —COOH, pyridyl, —NR²₂, and —SR⁴, where R², R⁴ are each hydrogen or an alkyl radical having from 1 to 6 carbon atoms and R⁴ may also may be —SR²;
Z: a head group selected from the group consisting of —SR⁴, —SiX₃, —COOH, and —C(O)NHOH, where X comprises halogen or an alkoxy group having from 1 to 6 carbon atoms and R⁴ is selected from the group consisting of hydrogen, an alkyl radical having from 1 to 6 carbon atoms and SR²; and
R¹: a radical selected from the group consisting of an alkylene radical having from 1 to 6 carbon atoms, an arylene radical having from 6 to 18 carbon atoms and an aralkylene radical having from 7 to 30 carbon atoms, where the radicals may also be perfluorinated or partially fluorinated.

4. The process as claimed in claim 1, wherein at least the sections of the substrate surface are surface-treated so that groups for bonding of the head groups are provided.

5. The process as claimed in claim 1, wherein, to apply the MOF layer, a solution of at least one metal ion and at least one linker molecule that is at least bidentate is prepared and the solution is brought into contact with at least the sections of the substrate surface.

6. The process as claimed in claim 5, wherein the solution is prepared by dissolving the at least one metal ion and the at least one linker molecule that is at least bidentate in a concentration close to the saturation limit of the MOF at a first, relatively high temperature, at least the sections of the substrate surface are brought into contact with the solution and the solution is cooled to a second, lower temperature at which the MOF grows on at least the sections of the substrate surface.

7. The process as claimed in claim 5, wherein the solution of the at least one metal ion and the at least one linker molecule that is at least bidentate is prepared in the presence of the substrate surface.

8. The process as claimed in claim 5, wherein the layer of the MOF is produced by treating at least the sections of the substrate surface sequentially at least with a solution of the at least one metal ion and with a solution of the at least one linker molecule that is at least bidentate.

9. The process as claimed in claim 1, wherein the at least one metal ion of the MOF is selected from the group consisting of Zn, Sn, In, Ti, Cu, and Fe.

10. The process as claimed in claim 5, wherein the at least one linker molecule that is at least bidentate is selected from the group consisting of compounds of the formula Z-R⁵-Z, where:
Z: a group selected from the group consisting of a carboxyl group, a carbamide group, a hydroxy group, a thiol group, an amino group and a pyridyl group;
R⁵: an at least divalent hydrocarbon radical selected from the group consisting of 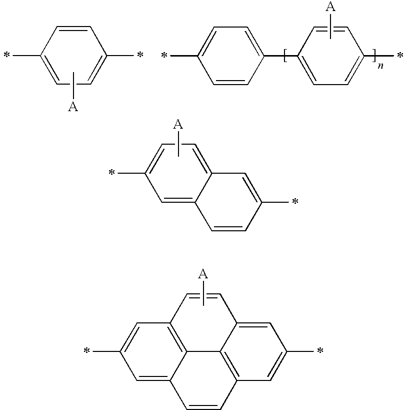
where n is an integer from 1 to 5 and A is selected from the group consisting of hydrogen, alkyl groups having 1-6 carbon atoms, alkenyl groups having 2-6 carbon atoms, alkoxy groups having 1-6 carbon atoms and from 1 to 3 oxygen atoms, halogen atoms or amino groups, with A being able to be identical or different on each occurrence and R⁵ also being able to be a single bond when Z is a pyridyl group.

11. The process as claimed in claim 1, wherein the substrate is comprises a silicon wafer.

12. The process as claimed in claim 1, wherein an active metal is incorporated into the layer of the MOF.

13. A composite comprising a substrate and a highly porous layer applied to at least sections of a substrate surface of the substrate, wherein the layer is made up of an MOF, which is bound to the substrate surface with a layer of spacer molecules, wherein the spacer molecules have at least one anchor group for metal ions and at least one head group which can bond to the substrate surface.

14. The composite as claimed in claim 13, wherein the MOF is made up of at least one metal ion and at least one linker molecule that is at least bidentate.

15. The composite as claimed in claim 13, wherein the metal ion is selected from the group consisting of Zn, Sn, In, Ti, Cu, and Fe.

16. The composite as claimed in claim 13, wherein the thickness of the highly porous layer is less than 100 μm.

17. The composite as claimed in claim 13, wherein an active metal has been incorporated into the highly porous layer.
